(19) United States
(12) Patent Application Publication
(10) Pub. No.: US 2001/0030025 A1
(43) Pub. Date: Oct. 18, 2001

(54) Plasma treatment method and apparatus

(76) Inventor: Tsukasa Fujita, Osaka (JP)

Correspondence Address: SMITH PATENT OFFICE, 1901 PENNSYLVANIA AVENUE N W, SUITE 200, WASHINGTON, DC, 20006

(21) Appl. No.: 09/833,819

(22) Filed: Apr. 13, 2001

(30) Foreign Application Priority Data
Apr. 14, 2000 (JP) 2000-114345

(51) Int. Cl. H05H 1/24

(52) U.S. Cl. 156/345; 427/569; 118/723 E

(57) ABSTRACT

A plasma treatment apparatus and method are disclosed. The plasma treatment apparatus has a discharge unit with at least one discharge electrode assembly disposed on a generally rectangular-shaped housing in a position that is offset from being coaxial with a longitudinal axis of the discharge unit housing. A plurality of discharge units can be arranged side by side so that their discharge electrodes are alternately disposed with respect to one another in order to treat a wide work surfaces that are wider than the distance between discharge electrodes.

### BACKGROUND OF THE INVENTION

1. Field of the invention

The present invention relates to a discharge unit of a plasma treatment apparatus, an arrangement of the discharge units and a plasma treatment method of treating wide work surfaces.

2. Description of the Related Art

Plasma treatment apparatuses have been widely used to form irregularities, on the order of a micron, on the outer surface of a work object. Such a plasma treatment apparatus can also be used to modify the outer surface of a work object.

Various plasma treatment apparatuses for modifying the outer surface qualities and properties of a work object are known from, for example, Japanese Unexamined Patent Publication Nos. 5-339398, 6-163143, 6-336529, 8-081573, 10-241827, 10-067869, 10-241827, 10-309749, 11-060759 and 11-279302.

One of the plasma treatment apparatuses that has been available on the market comprises a discharge unit having a pair of electrodes disposed so that they face each other. While applying a high voltage discharge to the electrodes, a gas stream is injected between the electrodes to generate an arc-shaped corona discharge between the electrodes. This produces a plasma around the corona discharge. The plasma is applied to the work object in order to modify its surface qualities or its surface properties. The modification of the qualities and properties of the outer surface of the work object is performed by activating the outer surface of the work with the plasma. As disclosed in Japanese Unexamined Patent Publication No. 6-163143, the plasma treatment is suitable for modification of surfaces of many materials such as plastics, paper, metals and ceramics.

The following examples are practical applications of plasma treatment:

(1) Applying plasma treatment to plastics, paper, metals or glass before printing on them. This increases adhesion of the print ink to the surface of the material.

(2) Applying [the] plasma treatment to films before applying a binder to them. This increases adhesion of the binder to the surface of the film.

(3) Applying plasma treatment to base substances before coating them. This increases adhesion of the coating film to the surface.

(4) Applying plasma treatment to a work object transforms organic matter, which is a source of smudges, into H₂O and CO₂. This removes smudges from the surface of the work object.

In the plasma treatment apparatus, a high discharge voltage is applied to the electrodes and a gas stream is provided between the electrodes to generate an arc-shaped corona discharge between the electrodes. The effective treatment area of the plasma generated by the discharge electrodes is locally limited. Therefore, when a work object has a surface area to be treated that is larger than the effective treatment width of a discharge electrode assembly, it is necessary to arrange a plurality of discharge units side by side to substantially expand the effective treatment width. However, in this situation, an undesirable discharge between each adjacent discharge electrode assemblies is possible.

### SUMMARY OF THE INVENTION

It is therefore an object of the present invention to provide a plasma treatment apparatus with a pair of discharge electrodes and a specially designed discharge unit that can prevent an occurrence of undesirable discharge between adjacent discharge units when a plurality of discharge units are arranged side by side.

It is another object of the present invention to provide a plasma treatment method of plasma treating a work object with a wide surface area.

According to one aspect of the present invention, the above objects can be accomplished by a plasma treatment apparatus that forms an arc-shaped corona discharge while applying a high voltage and a gas. The plasma treatment apparatus comprises a discharge unit for treating a treatment surface of a work object with plasma. The discharge unit includes a discharge unit housing having a generally rectangular cross section and a discharge electrode assembly comprising at least two discharge electrodes. The discharge electrode assembly is disposed on a front end of the discharge unit housing in a position that is offset from being coaxial with a longitudinal axis of the discharge unit housing.

Then a plurality of discharge units can be arranged so that every other discharge unit is rotated 180 degrees about its longitudinal axis and placed next to an adjacent discharge unit. This spaces the respective discharge electrode assemblies apart thereby avoiding the unwanted discharge that can occur when they are disposed adjacent to each other. Therefore, this arrangement provides a wide distance between adjacent discharge electrode assemblies and allows a work object with a wide treatment surface to be treated by more than one discharge electrode assembly at the same time.

According to another aspect of the present invention, the above objects are accomplished by a plasma treatment method for treating a treatment surface of a work object entering a plasma treatment station with plasma produced by an arc-shaped corona discharge that is generated by and between at least two discharge electrodes when a gas is passed between the discharge electrodes while applying a high voltage to the discharge electrodes. The plasma treatment method comprises arranging a plurality of discharge electrode assemblies so that the discharge electrode assemblies are disposed adjacent to a path of movement of the work object and so that the discharge electrode assemblies collectively extend transversely and adjacent to the path of movement of the work object. The step of arranging includes disposing at least two of the discharge electrode assemblies apart from each other in a direction of movement of the work object. The method also includes injecting gas between the discharge electrodes while simultaneously applying a high voltage to the discharge electrodes so as to treat the treatment surface of the work object over an area that is wider than a distance between the discharge electrodes of each discharge electrode assembly.

According to still another aspect of the present invention, the above objects are accomplished by a plasma treatment method for treating a treatment surface of a work object entering a plasma treatment station with plasma produced by an arc-shaped corona discharge that is generated by and between at least two discharge electrodes when a gas is passed between the discharge electrodes while applying a high voltage to the discharge electrodes. The plasma treatment method comprises the steps of arranging a plurality of sets of discharge electrodes relative to the work object so as to spatially divide the treatment surface into treatment subsections that are substantially adjacent to one another in a direction transverse to a direction of movement of the work object entering the plasma treatment station. The step of arranging includes locating the sets of discharge electrodes apart from each other by an effective width of the corona discharge generated by each set of discharge electrodes. The method also includes simultaneously treating the treatment subsections with plasma formed by the corona discharge generated by sets of discharge electrodes, respectively.

### BRIEF DESCRIPTION OF THE DRAWINGS

The above and other objects and features of the present invention will be clearly understood from the following description with respect to the preferred embodiment thereof when considered in conjunction with the accompanying drawings, wherein the same reference numerals have been used to denote the same or similar parts or elements and in which:

FIG. 1 is a schematic view of a plasma treatment apparatus according to a preferred embodiment of the present invention.

FIG. 2 is a front perspective view of a discharge unit of the plasma treatment apparatus shown in FIG. 1.

FIG. 3 is a longitudinal cross sectional view of the discharge unit shown in FIG. 2.

FIG. 4 is a schematic top view showing plasma treatment using a twin-head plasma treatment apparatus according to the present invention.

FIG. 5A is a front view of a discharge electrode assembly according to the present invention.

FIG. 5B is a front view of another discharge electrode assembly according to the present invention.

FIG. 5C is a front view of still another discharge electrode assembly according to the present invention.

FIG. 6 is a block diagram showing an electric system for the plasma treatment apparatus shown in FIG. 1.

FIG. 7 is a schematic illustration showing synchronous control of a three-head plasma treatment apparatus according to the present invention.

FIG. 8 is a time chart showing synchronous corona discharge using the three-head plasma treatment apparatus according to the present invention.

FIG. 9 is a flowchart illustrating a sequence routine for controlling the three-head plasma treatment apparatus according to the present invention.

FIG. 10 is a flowchart illustrating a sequence routine for synchronous control of the three-head plasma treatment apparatus according to the present invention.

### DETAILED DESCRIPTION OF THE PREFERRED EMBODIMENTS

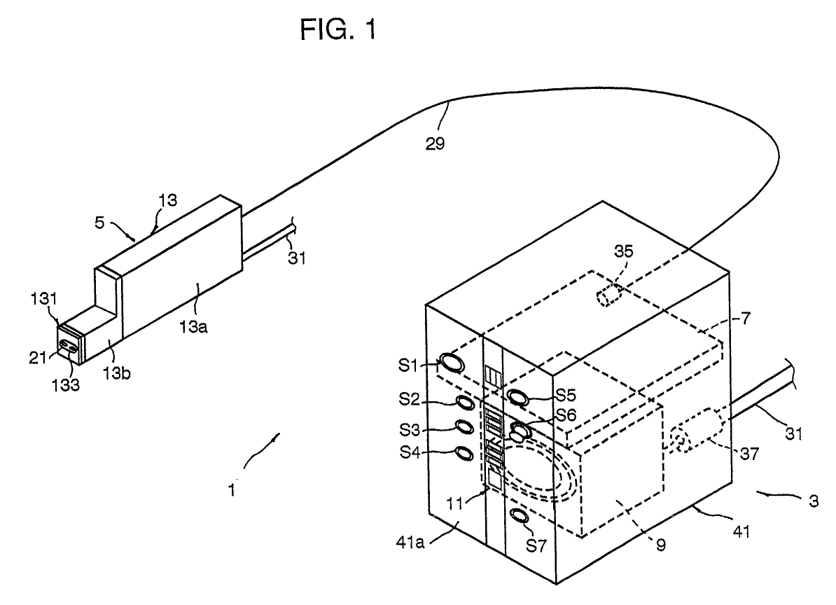

Referring to the drawings in detail, and in particular, to FIG. 1 to 3 which schematically show an entire setup of a plasma treatment apparatus 1 in accordance with an embodiment of the present invention, the plasma treatment apparatus 1 comprises a control unit 3 and a discharge head unit 5. The control unit 3 has a housing 41 in which a baseboard 7 with a control circuit installed thereon and an air pump 9 as a gas supply source are received. The air pump 9 may be of a type having a pair of diaphragms disposed in front and rear positions. This diaphragm type of air pump has an advantage in that it excels at reliability in connection with a long term to use because of a small number of component parts. The control circuit includes a main power circuit, a CPU, a memory and other necessary parts. The housing 41 has an operating panel 41a at its front on which switches S1-S7 and a display unit 11 are arranged. The switches S1-S7 include at least a discharge starting switch, a discharge interruption switch. The display unit 11 displays various digital information including a discharge time.

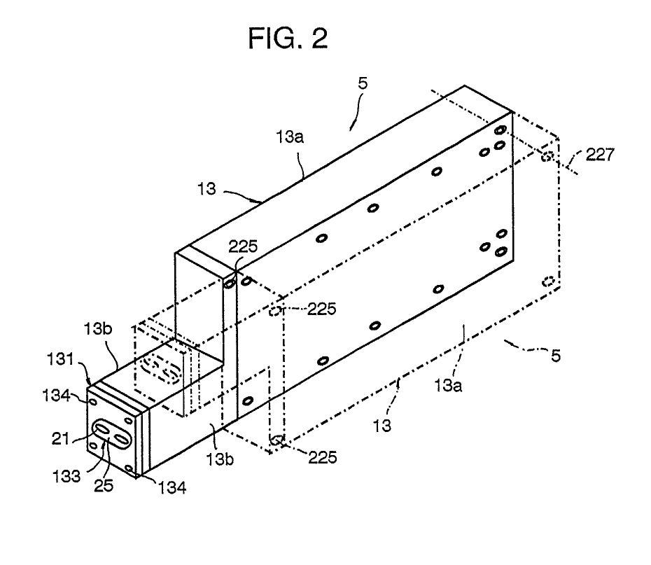

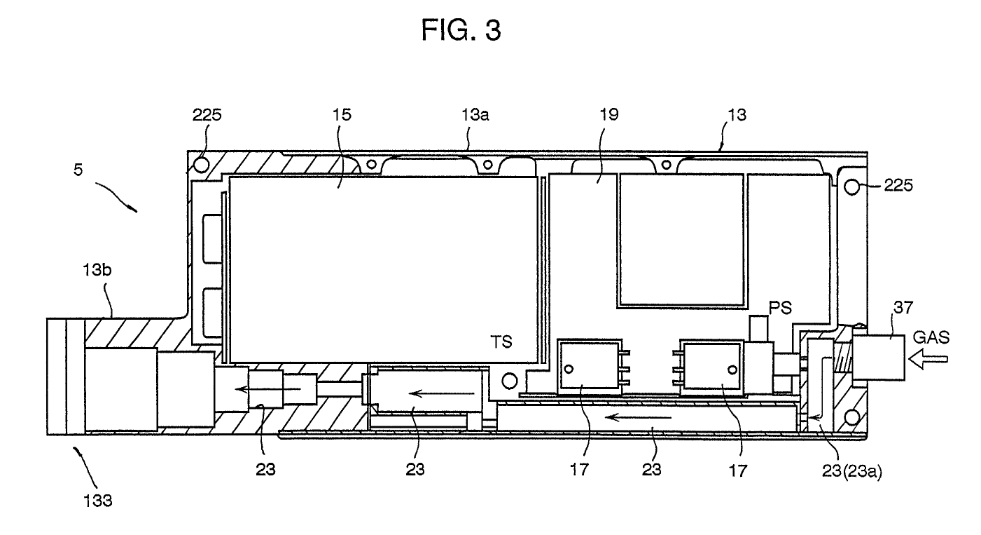

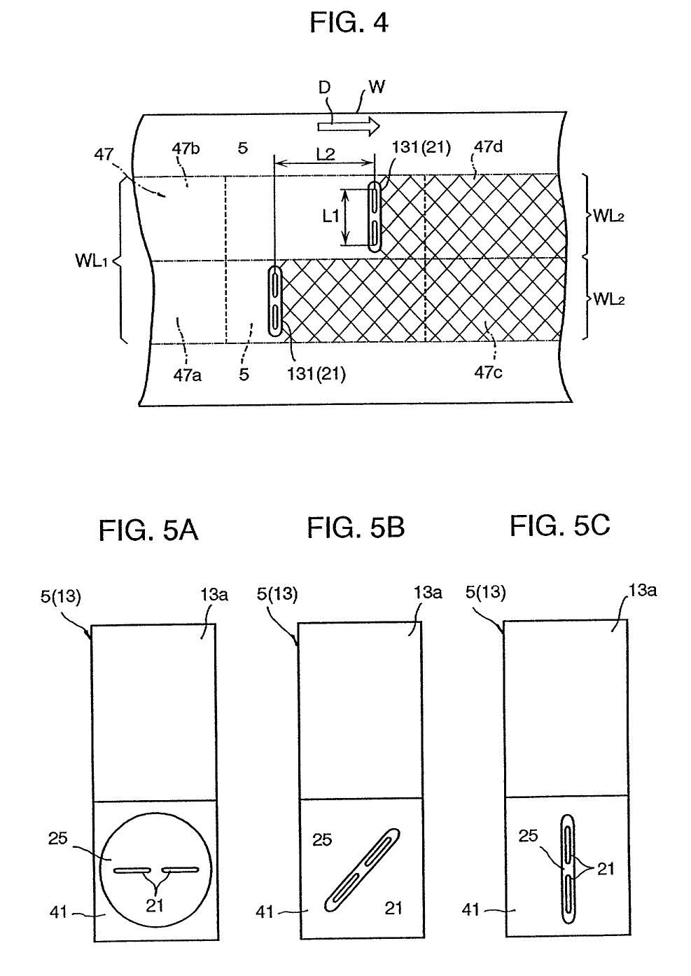

Referring to FIGS. 2 and 3 showing the discharge head unit 5 in detail, the discharge unit 5 has a unit housing 13 comprising a main housing section 13a and a head housing section 13b at a front of the main housing section 13a. The main housing section 13a, which has a generally rectangular-shaped cross section, is provided with a baseboard 19 on which an oscillation circuit is installed. The oscillation circuit includes at least a high-voltage generating circuit 501 (see FIG. 4) which includes a high-frequency step-up transformer 15 and a switching element 17 operative to impress and shut off a current to a primary coil of the high-frequency step-up transformer 15. This arrangement permits a small size of a transformer to employ, so that a compact unit housing 13 is available though the discharge unit 5 generates a high discharge voltage. The head housing 13b at its front is provided with a pair of discharge electrodes 21. The unit housing 13 is formed with a gas passage 23. The gas passage 23 extends adjacent to and along one of side walls thereof as shown in FIG. 3 and leads to a gas injection port 25 opening in the head housing 13b (see FIG. 2). The gas injection port 25 is shaped like a horizontal slot which is long sideways.

A high discharge voltage generated by the discharge unit 5 is impressed to the discharge electrodes 21 as sign-wave A. C. power in opposite phase, respectively. In typical application of the plasma treatment apparatus 1, a voltage impressed between the discharge electrodes 21 is approximately 8 kVrms and has a frequency of approximately 20 to 25 kHz.

The control unit 3 and the discharge unit 5 are connected by means of a twin-lead cable 29, including a power cable and a control signal cable, and a gas guide tube 31. Both cable 29 and gas guide tube 31 are detachably connected to the control unit 3 and the discharge unit 5 by means of connectors 35 and 37 (connectors for the discharge unit 5 are hidden behind the unit housing 13 in FIG. 13, respectively. In place of the air pump 9, an external gas supply source may be used. In this case, the external gas supply source (not shown) is connected to the discharge unit 5 through the gas guide tube 31.

Air is into the gas passage 23 of the discharge unit 5 through the gas guide tube 31 fed by the air pump 9 or a blower and discharged from the discharge unit 5 through the gas injection port 25. A control signal is fed to the built-in high-voltage generating circuit 501 from the control unit 3 through the cable 29 to control supply of a voltage between the discharge electrodes 21. During operation of the plasma treatment apparatus 1, when a high discharge voltage is impressed between the discharge electrodes 21, a discharge arc is generated between the discharge electrodes 21 and then is swelled outward in a form of arch by an air stream discharged through the gas injection port 25.

The unit housing 13 comprises a rectangular box shaped main housing section 13a and a rectangular box shaped head housing section 13b at a front of the main housing section 13a (see FIG. 2). The head housing section 13b is the same in width as the main housing section 13a but shorter in height than the main housing section 13a as seen from the front of the of the unit housing 13. The head housing section 1b is in alignment with the main housing section 13a at their lower edges as seen in FIG. 2. A discharge electrode assembly 41 including a pair of discharge electrodes 21 and a gas injection port 25 is detachably secured to the head housing section 13b by a plurality of bolts 43.

Because the discharge unit housing 13 has the head housing section 13b off set to the bottom of the main housing section 13a, in the case where a plurality of the discharge units 5 are transversely arranged side by side in order to apply plasma to a work having a wide treatment surface area to which the plasma treatment is applied, their discharge electrode assemblies 47 are positioned far away from each other by positioning every other unit upside down such as shown by an imaginary line in FIG. 2. In other words, the adjacent discharge units 5 which are arranged side by side so as to place every other head housing section 3b in revered position with respect to the adjacent every other head housing section 3b. This uneven arrangement prevents an occurrence of undesirable discharge between adjacent discharge units 5. Furthermore, even when the discharge unit 5 has a relatively small narrow width, the side-by-side multi-head arrangement has a required projection minimized to the minimum.

Specifically, as shown in FIG. 4, a twin-head plasma treatment apparatus is used to apply the plasma treatment to a strip-like work W, moving in a direction indicated by an arrow D, which has a treatment surface area 47 having a width WL1 greater than, for example twice as wide as, an effective treating width WL2 of the individual discharge unit 5. In order to treat the treatment surface area 47 of the strip-like work W, two discharge units 5 are coupled together as a twin-head discharge unit so as to provide an effective treating area twice as wide as the effective treating width WL2 of the individual discharge unit 5, which meets the width WL1 of the treatment surface area 47.

The discharge units 5 of the twin-head discharge unit are transversely arranged side by side with their discharge electrode assemblies 41 placed uneven with each other in the direction of movement D of the work W Then, the unit housings 13 at either one or both of their front and rear ends are coupled together by fastening bolts 47 onto threaded bores 45 (see FIG. 2). The threaded bores 45 forms positioning means for positioning the discharge units 5 with respect to each other in the direction of movement D of the work W. The positioning means for positioning and coupling two discharge units 5 is known in various forms and may take any well known form. For example, the discharge units 5 may be provided with a complementary fitting key and key-way connecting arrangement as the positioning means.

In the twin-head discharge unit, the adjacent discharge units 5 are arranged with their discharge electrode assemblies 41 not positioned in a straight line transversely across the treatment surface area 47 of the strip-like work W but positioned uneven in the direction of movement D of the strip-like work W. In general, the multi-head plasma treatment apparatus comprising a plurality of discharge units 5 arranged transversely side by side is configured such that the discharge electrode assembly 41 of every other discharge unit 5 is positioned in a first straight line transversely across the treatment surface area 47 of the strip-like work W and the discharge electrode assembly 41 of another every other discharge unit 5 is positioned in a second straight line transversely across the treatment surface area 47 of the strip-like work W displaced from the first line in the direction of movement D of the strip-like work W. Accordingly, the discharge units 5 can be arranged such as to separate each adjacent discharge electrode assemblies 41 with a distance L2 greater than an inter-distance L1 between the discharge electrodes of each discharge electrode assembly 41 as shown in FIG. 4. This alternately uneven arrangement of the discharge units 5 prevents an occurrence of undesirable discharge between each adjacent discharge units 5.

Describing the twin-head discharge unit from a standpoint of plasma treatment shown in FIG. 4, the treatment surface area 47 of a work W is divided into two adjacent subsections 47a and 47b which are allocated to the two discharge units 5, respectively. The two discharge units 5 apply plasma to the two adjacent subsections 47a and 47b concurrently but at different parts apart from each other with the distance L2 in the direction of movement D of the work W. Shaded parts of the treatment surface area 47c and 47d are parts which are already plasma treated.

The gas injection port 25 of the discharge electrode assembly 41 is not limited to a slot which is long sideways and may have different configurations. For example, the gas injection port may be of a circular or an almost circular configuration as shown in FIG. 5A, of a slot-like configuration extending slantwise as shown in FIG. 5B, or of a vertical slot like configuration such as shown in FIG. 5C. The configuration and position of the gas injection port 25 can be determined in consideration of a treatment surface area of works, a treating speed, a work transfer speed, etc.

In the case of either using a multi-head plasma treatment apparatus of the present invention or using conventional multi-head plasma treatment apparatus, it is necessary to perform synchronous control of a plurality of discharge units 5. Synchronization of the discharge units 5 may be performed by providing the control unit 3 for the respective discharge units 5 with a trigger signal so as to cause synchronous operation of the control units 3 when an arrival of a work W is detected to reach a specified position or by causing the control units 5 to provide the discharge units 5 with start command signals, respectively, when a control computer receives the trigger signal. Otherwise, one of the control units 3 for the discharge units 5 of the multi-head plasma treatment apparatus may be used as a main control unit. Specifically, one of control units of a multi-head plasma treatment apparatus is used as a main control unit and the remaining control units are used as a subsidiary control unit. When the main control unit receives a trigger signal when an arrival of a work W at a specified position is detected, it provides the subsidiary control units with start command signals, respectively, simultaneously with starting itself. Similarly, in the case of either using a multi-head plasma treatment apparatus of the present invention or using conventional multi-head plasma treatment apparatus, synchronous control of a plurality of discharge units 5 may be performed by making the respective control units 3 have common control. Although the common control may be managed by an extra computer (not shown), one of the control units 3 may be used as a main control unit and the remaining control units may be used as subsidiary control units. The main control unit transfers data of control commonly to the respective subsidiary control units, and then, the subsidiary control units control separately the discharge units peculiar thereto, respectively, on the basis of the data of control. In this type of synchronization, the plasma treatment is timely started by delivering a trigger signal to all of the control units when a work is detected to enter a plasma treatment station.

The following description is directed to the multi-head plasma treatment apparatus as an example that has a one of the control units as a main unit and the remaining control units as subsidiary units.

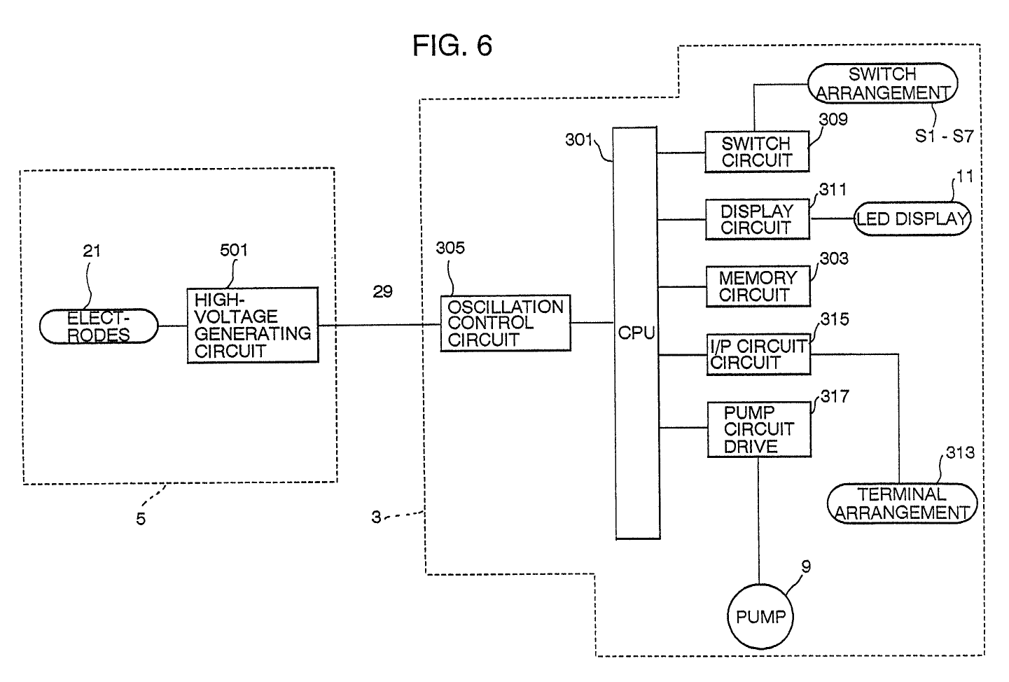

FIG. 6 schematically shows the plasma treatment apparatus 1 that is operated by synchronous control. The control unit 3 comprises a CPU 301, a memory 303 connected to the CPU 301, an oscillator control circuit 305, a switching circuit 309, an exciting circuit 311 for exciting the display unit 11, an input/output circuit 315 connected to a terminal arrangement 313 on a rear panel of the housing 41 of the control unit 3 and a pump drive circuit 317 for driving the air pump 9. The discharge unit 5 comprises at least a high-voltage generating circuit 501. These circuits of the control unit 3 and the discharge unit 5 are electrically coupled by the cable 29. As shown, high-voltage generating circuit 501 is electrically coupled to the oscillator control circuit 305. One of terminals of the terminal arrangement 313 of each control unit is used to connect the control unit to another control unit and used as a synchronous signal input/output terminal.

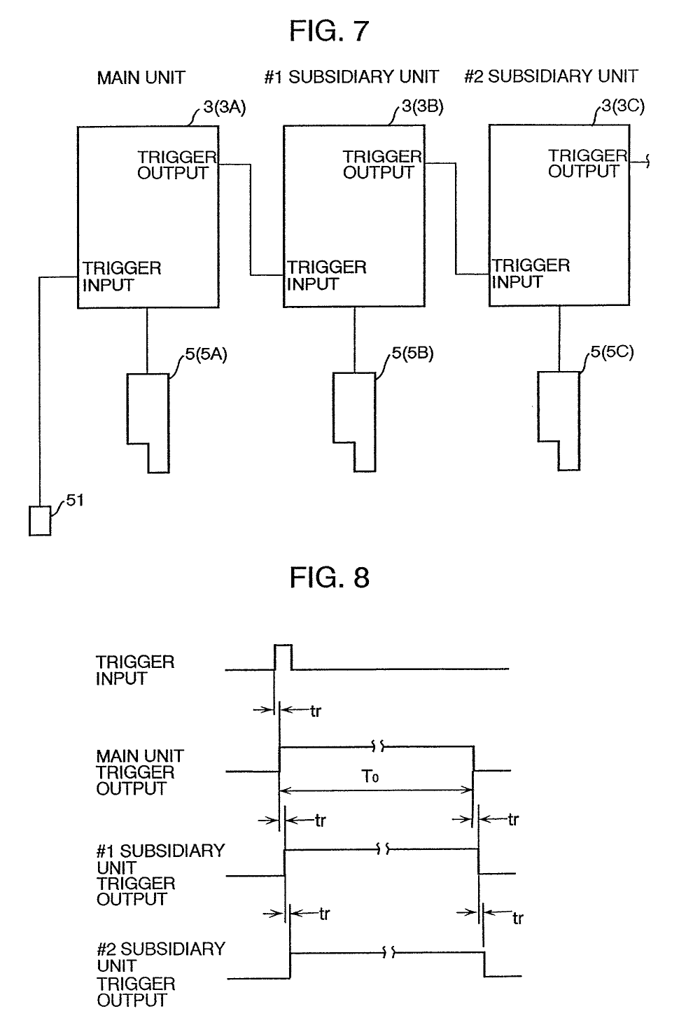

For example, as shown in FIG. 7, a control unit 3A for one of three discharge units 5 is used as the main control unit, and the remaining control units 3B, 3C, . . . (#1, #2, . . . subsidiary control units) are used as subsidiary control units connected to the main control unit 3A in series. A work sensor 225, which is disposed in a specific position in the plasma treatment station, provides the control unit 3 with a trigger signal when detecting a work W as shown in FIG. 7. When the main control unit 3A receives the trigger signal, the oscillator control circuit 305 of the main control unit 3A provides the high-voltage generating circuit 501 with an oscillation start signal. Then, the high-voltage generating circuit 501 starts generation of a high voltage with a time lag tr (which is due to a response delay of the high-voltage generating circuit 501) to cause the discharge electrodes 21 of the discharge unit SA to generate a corona discharge. The control unit 3A keeps the high-voltage generating circuit 501 of the discharge unit 5A to continue oscillation for a predetermined discharge duration, i.e. a plasma treatment time To. After a lapse of the plasma treating time To, the oscillator control circuit 305 of the main control unit 3A provides the high-voltage generating circuit 501 with an oscillation stop signal, then the high-voltage generating circuit 501 terminates oscillation so that the corona discharge disappears to terminate the plasma treatment. In this embodiment, the time lag tr is approximately 10 ms, which ha no practical influence on the plasma treatment.

As shown in FIG. 8, when the high-voltage generating circuit 501 of the main control unit 3A starts generation of a high voltage, the main control unit 3A provides the first subsidiary control unit (#1 subsidiary control unit) 3B with a trigger signal so that the oscillator control circuit 305 of the subsidiary control unit 3B provides the high-voltage generating circuit 501 of the discharge unit SB with an oscillation start signal. Then, the high-voltage generating circuit 501 start generation of a high voltage with a time lag tr to cause the discharge electrodes 21 of the discharge unit 5B to generate a corona discharge. The subsidiary control unit 3B keeps the high-voltage generating circuit 501 to continue oscillation for the predetermined discharge duration time, i.e. the plasma treatment time To. After a lapse of the plasma treating time To, the oscillator control circuit 305 of the subsidiary control unit 3B provides the high-voltage generating circuit 501 with an oscillation stop signal, then, the high-voltage generating circuit 501 terminates oscillation so that the corona discharge disappears to terminate the plasma treatment. The same operation occurs sequentially with respect to the remaining subsidiary control units 3C, . . . .

The synchronization of the discharge units 5 may be achieved by transferring data of plasma treatment conditions from the main control unit to the subsidiary control units. Transfer of the trigger signal between the adjacent control units 3 may be achieved by the use of an exclusive transfer line such as RS232C. For the synchronized operation of the discharge units, although two of the terminals of the terminal arrangement 311 are allocated to input and output signals, respectively, communication ports exclusive to the RS232 standard.

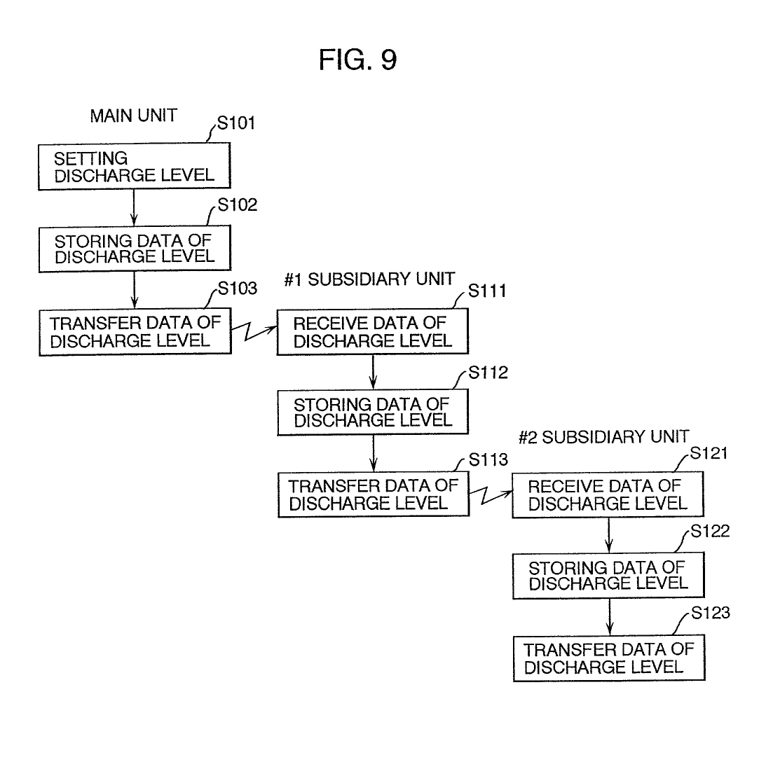

FIG. 9 is a flow chart illustrating a sequence routine of common control of a plurality of discharge units of the multi-head plasma treatment apparatus which is achieved by transferring data of plasma treating conditions. When the flow chart logic commences the control proceeds to a block at step S101 where the main control unit 3A is set up by, for example, manually setting a plasma treating time, selecting one of plasma treating programs stored in the memory 303, etc. After storing data of the set level of voltage waveform that is impressed to the discharge electrodes 21 of the discharge unit 5A in a RAM forming part of the memory 303 of the main control unit 3A at step S102, the main control unit 3 A transfers the data of the set level of voltage waveform to the first subsidiary control unit 3B at step S103.

When the first subsidiary control unit (#1 subsidiary control unit) 3B receives the data of the set level of voltage waveform at step S111, after storing the data of the set level of voltage waveform in a RAM forming part of the memory 303 of the first subsidiary control unit 3B at step S112, the second subsidiary control unit 3B transfers the data of the set level of voltage waveform to the second subsidiary control unit (#2 subsidiary control unit) 3C at step S113. In the same way, the third subsidiary control unit receives and stores the data of the set level of voltage waveform in a RAM forming part of the memory 303 of the second subsidiary control unit 3C and transfers the data of the set level of voltage waveform to the following subsidiary control unit through steps S121-123. With the common control sequence routine, the multi-head plasma treatment apparatus performs the common control.

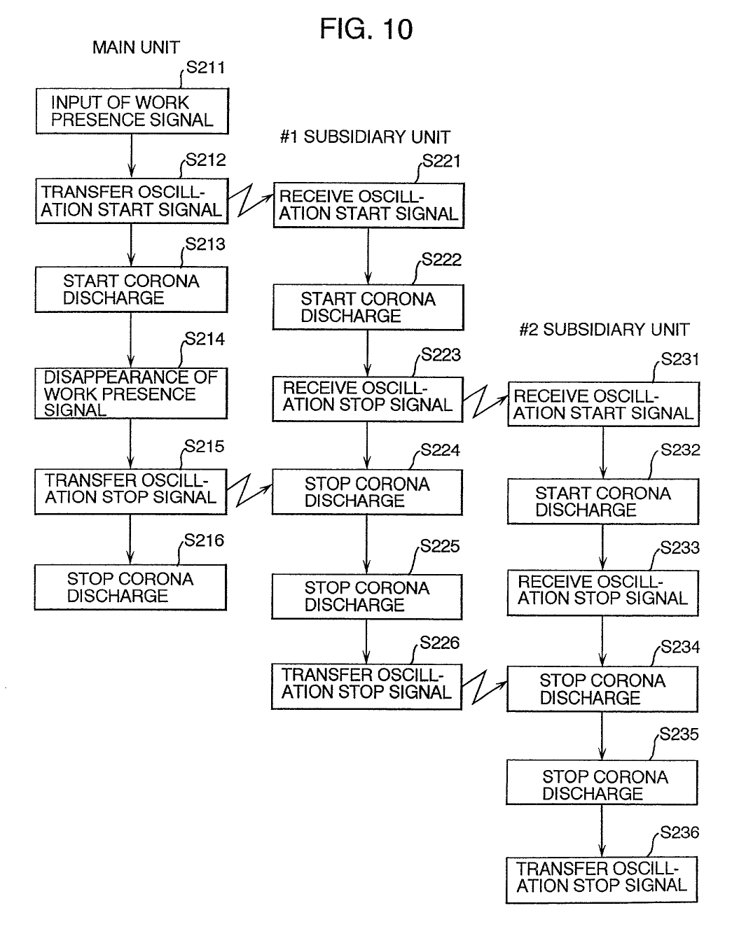

FIG. 10 is a flow chart illustrating a sequence routine of synchronous control of the multi-head plasma treatment apparatus. In order to perform the synchronous control of the multi-head plasma treatment apparatus, the plasma treating station is provided with work detection means (not shown) for detecting a work W entering the plasma treating station and continuously providing a signal (work presence signal) kept until the work W goes out of the plasma treatment station, in other words, as long as the work is present in the plasma treating station.

When the flow chart logic commences and the main control unit 3A receives a work presence signal at step S211, after providing the first subsidiary control unit 3B with an oscillation start command signal at step S212, the oscillator control circuit 305 of the main control unit 3A provides the high-voltage generating circuit 501 with an oscillation start signal at step S213. Then, the high-voltage generating circuit 501 starts generation of a high voltage to cause the discharge electrodes 21 of the discharge unit 5A to generate a corona discharge. The control unit 3A keeps the high-voltage generating circuit 501 of the discharge unit 5A to continue oscillation until the work presence signal disappears at step S214. Subsequent to the disappearance of the work presence signal, the main control unit 3A provides the first subsequent control unit 3B with an oscillation stop command signal at step S215 and, then, the oscillator control circuit 305 of the main control unit 3A removes the oscillation start signal at step to cause the discharge electrodes 21 of the discharge unit 5A to cause the high-voltage generating circuit 501 to terminate generation of the high voltage, so as thereby to cause the discharge electrodes 21 of the discharge unit 5A to terminate generation of the corona discharge at step S216.

The first subsidiary control unit 3B performs the same sequence as the main control unit 3A with receiving the oscillation start command signal and oscillation stop command signal from the main control unit 3A through steps S221-S226. In the same sequence, the remaining subsidiary control unit 3C performs the same sequence as the preceding control unit 3B with receiving the oscillation start command signal and oscillation stop command signal from the preceding subsidiary control unit 3B through steps S231-S236.

It is to be understood that although the present invention has been described in detail with respect to the preferred embodiments thereof, various other embodiments and variants may occur to those skilled in the art, which are within the scope and spirit of the invention, and such other embodiments and variants are intended to be covered by the following claims.

What is claimed is:

1. A plasma treatment apparatus for forming an arc-shaped corona discharge while applying a high voltage and a gas, said plasma treatment apparatus comprising:
a discharge unit for treating a treatment surface of a work object with plasma, said discharge unit including:
a discharge unit housing having a front end and a generally rectangular cross section; and
a discharge electrode assembly comprising at least two discharge electrodes, said discharge electrode assembly being disposed on the front end of said discharge unit housing in a position that is offset from being coaxial with a longitudinal axis of said discharge unit housing.

2. A plasma treatment apparatus as defined in claim 1, wherein said discharge unit housing includes a high voltage circuit for generating and applying a high voltage to said discharge electrodes.

3. A plasma treatment apparatus for forming an arc-shaped corona discharge while applying a high voltage and a gas, said plasma treatment apparatus comprising:
a plurality of discharge units for treating a treatment surface of a work object with plasma;
each of said discharge units including:
a discharge unit housing having a front end and a generally rectangular cross section; and
a discharge electrode assembly comprising at least two discharge electrodes, said discharge electrode assembly being disposed on the front end of said discharge unit housing in a position that is offset from being coaxial with a longitudinal axis of said discharge unit housing; and
wherein said plurality of said discharge units are arranged side by side so that each said discharge unit housing is alternately disposed in a reversed position with respect to each adjacent discharge unit housing.

4. A plasma treatment apparatus as defined in claim 3, wherein each of said discharge unit housings includes a high-voltage circuit for generating and applying high voltage to said discharge electrodes.

5. A plasma treatment method for treating a treatment surface of a work object entering a plasma treatment station with plasma produced by an arc-shaped corona discharge that is generated by and between at least two discharge electrodes when a gas is passed between the discharge electrodes while applying a high voltage to the discharge electrodes, said plasma treatment method comprising the steps of:
arranging a plurality of discharge electrode assemblies so that the discharge electrode assemblies are disposed adjacent to a path of movement of the work object and so that the discharge electrode assemblies collectively extend transversely and adjacent to the path of movement of the work object, said step of arranging including disposing at least two of the discharge electrode assemblies apart from each other in a direction of movement of the work object; and
injecting gas between the discharge electrodes while simultaneously applying a high voltage to the discharge electrodes so as to treat the treatment surface of the work object over an area that is wider than a distance between the discharge electrodes of each discharge electrode assembly.

6. A plasma treatment method as defined in claim 5, wherein said step of arranging further includes disposing the discharge electrode assemblies substantially along one of two areas extending transversely to the direction of movement of the work object.

7. A plasma treatment method as defined in claim 6, wherein said step of arranging further includes disposing alternate discharge electrode assemblies along one of the two areas extending transversely to the direction of movement of the work object and disposing the remaining alternate discharge electrode assemblies along the other of the two areas extending transversely to the direction of movement of the work object.

8. A plasma treatment method for treating a treatment surface of a work object entering a plasma treatment station with plasma produced by an arc-shaped corona discharge that is generated by and between at least two discharge electrodes when a gas is passed between the discharge electrodes while applying a high voltage to the discharge electrodes, said plasma treatment method comprising the steps of:
arranging a plurality of sets of discharge electrodes relative to the work object so as to spatially divide the treatment surface into treatment subsections that are substantially adjacent to one another in a direction transverse to a direction of movement of the work object entering the plasma treatment station, said step of arranging includes locating the sets of discharge electrodes apart from each other by an effective width of the corona discharge generated by each set of discharge electrodes; and
simultaneously treating the treatment subsections with plasma formed by the corona discharge generated by respective sets of discharge electrodes.
